(19) United States
(12) Patent Application Publication
(10) Pub. No.: US 2019/0234406 A1
(43) Pub. Date: Aug. 1, 2019

(54) PUMP DEVICE

(71) Applicant: Nidec Tosok Corporation, Zama-shi, Kanagawa (JP)

(72) Inventors: Kazuhiro HOMMA, Zama-shi (JP); Yosuke ITO, Zama-shi (JP)

(21) Appl. No.: 16/334,778

(22) PCT Filed: Sep. 25, 2017
(86) PCT No.: PCT/JP2017/034496

§ 371 Date: Mar. 20, 2019

(30) Foreign Application Priority Data
Sep. 30, 2016 (JP) 2016-195279

(51) Int. Cl. F04C 15/00; F04C 2/10; H02K 1/04; H02K 1/20; H02K 1/32; H02K 5/167; H02K 5/20; H02K 7/08; H02K 9/193; H02K 16/02

(52) U.S. Cl. CPC F04C 15/0096; F04C 2/10; H02K 1/04; H02K 1/20; H02K 1/32; F04C 2240/40; H02K 5/20; H02K 7/085; H02K 9/193; H02K 16/02; H02K 5/1675

(57) ABSTRACT

A pump device includes a shaft, a motor to rotate the shaft, and a pump driven by the motor via the shaft to discharge oil. The pump device includes a first flow path for oil to connect an interior of the pump and an interior of a housing, a second flow path for oil provided between a stator and a rotor included in the motor, a third flow path for oil disposed outside in a radial direction or inside in the radial direction of the stator and the rotor, and a fourth flow path to cause oil from the second flow path or the third flow path to flow into the pump.

### TECHNICAL FIELD

The present disclosure relates to a pump device.

### BACKGROUND ART

In recent years, an electric oil pump used in a transmission or the like has required responsiveness. In order to realize responsiveness in the electric oil pump, it is necessary to make a motor for an electric oil pump have a high output.

When the motor for an electric oil pump has a high output, a large current flows through a coil provided in the motor, the motor reaches a high temperature, and, for example, a permanent magnet provided in the motor may be demagnetized. For this reason, a cooling structure needs to be provided in the motor to minimize an increase in temperature of the motor.

Japanese Unexamined Patent Application Publication No. 2008-125235 discloses an electric motor including an oil supply mechanism configured to displace a relative positional relation between a stator and a rotor in an axial direction using a hydraulic pressure of oil according to a rotational speed of the rotor and cool the rotor using the oil.

However, the electric motor disclosed in Japanese Unexamined Patent Application Publication No. 2008-125235 cannot simultaneously cool the stator and the rotor using the oil.

### SUMMARY OF THE DISCLOSURE

Example embodiments of the present disclosure provide pump devices that each include a structure that simultaneously cools a stator and a rotor and has an excellent cooling effect.

A first example embodiment of the present disclosure is a pump device including a shaft that rotates about a central axis extending in an axial direction, a motor to rotate the shaft, and a pump disposed on one side of the motor in the axial direction, driven by the motor via the shaft to discharge oil, wherein the motor includes a rotor that rotates around the shaft, a stator facing the rotor, and a housing to accommodate the rotor and the stator, the pump includes a pump rotor attached to the shaft, and a pump case to accommodate the pump rotor and including a suction port that suctions the oil and a discharge port that discharges the oil, and the pump device further includes a first flow path for the oil to connect an interior of the pump and an interior of the housing, a second flow path for the oil provided between the stator and the rotor, a third flow path for the oil provided outside in a radial direction or inside in the radial direction of the stator and the rotor, and a fourth flow path to cause the oil from the second flow path or the third flow path to flow into the pump.

According to the first example embodiment of the present disclosure, it is possible to provide a pump device having a structure that simultaneously cools a stator and a rotor and an excellent cooling effect.

The above and other elements, features, steps, characteristics and advantages of the present disclosure will become more apparent from the following detailed description of example embodiments with reference to the attached drawings.

### BRIEF DESCRIPTION OF THE DRAWINGS

FIG. 1 is a cross-sectional view showing a pump device according to a first example embodiment of the present disclosure.

FIG. 2 is a view schematically showing a main portion of a pump device according to the first example embodiment of the present disclosure.

FIG. 3 is a plan view of a stator according to the first example embodiment of the present disclosure.

FIG. 4A is a partially enlarged view of a flow path according to the first example embodiment of the present disclosure.

FIG. 4B is a partially enlarged view of the flow path according to the first example embodiment of the present disclosure.

FIG. 5 is a view showing a variant of the flow path according to the first example embodiment of the present disclosure.

FIG. 6 is a cross-sectional view showing a pump device according to a second example embodiment of the present disclosure.

FIG. 7 is a cross-sectional view showing a pump device according to a third example embodiment of the present disclosure.

FIG. 8 is a cross-sectional view showing a variant of the pump device according to the third example embodiment of the present disclosure.

### DETAILED DESCRIPTION OF THE EXAMPLE EMBODIMENTS

Hereinafter, pump devices according to example embodiments of the present disclosure will be described with reference to the accompanying drawings. Further, the scope of the present disclosure is not limited to the following example embodiments and arbitrary modifications may be made without departing from the technical spirit of the present disclosure. In addition, in the following drawings, for the purpose of easy understanding of components, there are cases where sizes, numbers, or the like, in structures are different from those in the actual structure.

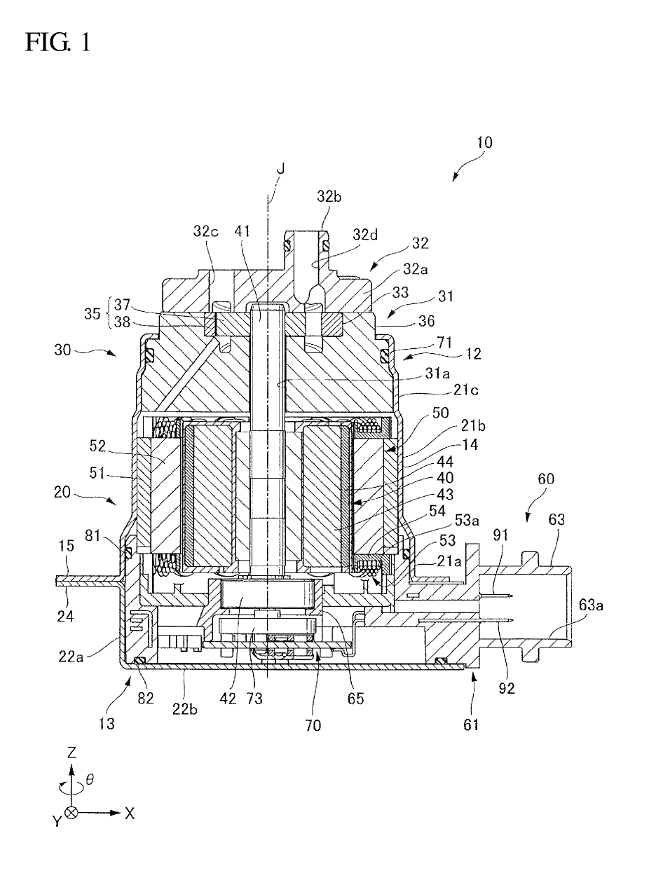

In addition, in the drawings, an XYZ coordinate system is shown as an appropriate 3-dimensional orthogonal coordinate system. In the XYZ coordinate system, a Z-axis direction is parallel to the axial direction of the center axis J shown in FIG. 1. An X-axis direction is a direction parallel to a lengthwise direction of a bus bar assembly 60 shown in FIG. 1, i.e., a leftward/rightward direction in FIG. 1. A Y-axis direction is a direction parallel to a widthwise direction of the bus bar assembly 60, i.e., a direction perpendicular to both of the X-axis direction and the Z-axis direction.

In addition, in the following description, a positive side (a +Z side) in the Z-axis direction is referred to as “a front side” and a negative side (a −Z side) in the Z-axis direction is referred to as “a rear side.” Further, the rear side and the front side are names used for simple description and are not limited to actual positional relations or directions. In addition, the direction (the Z-axis direction) parallel to the central axis J is simply referred to as “an axial direction,” a radial direction about the central axis J is simply referred to as “a radial direction,” and a circumferential direction about the central axis J, i.e., around the central axis J (a θ direction) is simply referred to as “a circumferential direction” unless the context clearly indicates otherwise.

Further, in the specification, extending in the axial direction also includes a case of extending in a direction inclined within a range of less than 45° with respect to the axial direction, in addition to a case in which of strictly extending in the axial direction (the Z-axis direction). In addition, in the specification, extending in the radial direction also include a case in which it extends in a direction inclined within a range of less than 45° with respect to the radial direction, in addition to a case in which it strictly extends in the radial direction, i.e., a direction perpendicular to the axial direction (the Z-axis direction).

### First Example Embodiment

FIG. 1 is a cross-sectional view showing a pump device 10 of the example embodiment.

The pump device 10 of the example embodiment has a shaft 41, a motor unit 20, a housing 12, a cover 13 and a pump unit 30. The shaft 41 is rotated about the central axis J extending in the axial direction. The motor unit 20 and the pump unit 30 are provided to be arranged in the axial direction.

As shown in FIG. 1, the motor unit 20 has the cover 13, a rotor 40, a stator 50, a bearing 42, a control device 70, the bus bar assembly 60 and a plurality of O-rings. The plurality of O-rings have a front side O-ring 81 and a rear side O-ring 82.

The rotor 40 is fixed to an outer circumferential surface of the shaft 41. The stator 50 is disposed outside the rotor 40 in the radial direction. That is, the motor unit 20 is an inner rotor type motor. The bearing 42 rotatably supports the shaft 41. The bearing 42 is held by the bus bar assembly 60. The bus bar assembly 60 is connected to an external power supply and supplies current to the stator 50.

The housing 12 holds the motor unit 20 and the pump unit 30. The housing 12 opens toward the rear side (the −Z side), and an end portion of the bus bar assembly 60 on the front side (the +Z side) is inserted into an opening section of the housing 12. The cover 13 is fixed to the rear side of the housing 12. The cover 13 covers the rear side of the motor unit 20. That is, the cover 13 covers at least a part of the bus bar assembly 60 on the rear side (the −Z side) and is fixed to the housing 12.

The control device 70 is disposed between the bearing 42 and the cover 13. The front side O-ring 81 is provided between the bus bar assembly 60 and the housing 12. The rear side O-ring 82 is provided between the bus bar assembly 60 and the cover 13. Hereinafter, respective parts will be described in detail.

### Housing

As shown in FIG. 1, the housing 12 has a cylindrical shape. More specifically, the housing 12 has a multi-step cylindrical shape, both ends of which open about the central axis J. A material of the housing 12 is, for example, a metal. The housing 12 holds the motor unit 20 and the pump unit 30. The housing 12 has a cylindrical section 14 and a flange section 15.

The flange section 15 extends from an end portion of the cylindrical section 14 on the rear side toward an outer side of the radial direction. The cylindrical section 14 has a cylindrical shape about the central axis J. The cylindrical section 14 has a bus bar assembly insertion section 21a, a stator holding section 21b and a pump body holding section 21c in sequence from the rear side (the −Z side) to the front side (the +Z side) in the axial direction (the Z-axis direction).

The bus bar assembly insertion section 21a surrounds the end portion of the bus bar assembly 60 on the front side (the +Z side) from the outer side in the radial direction from the central axis J. The bus bar assembly insertion section 21a, the stator holding section 21b and the pump body holding section 21c have cylindrical shapes that are concentric with each other, diameters of which decrease in sequence.

That is, the end portion of the bus bar assembly 60 on the front side is disposed on an inner side of the housing 12. The outer side surface of the stator 50, i.e., an outer side surface of a core back section 51 (to be described below) is fitted into an inner side surface of the stator holding section 21b. Accordingly, the stator 50 is held by the housing 12. An outer circumferential surface of a pump body 31 is fixed to an inner circumferential surface of the pump body holding section 21c.

### Rotor

The rotor 40 has a rotor core 43 and a rotor magnet 44. The rotor core 43 surrounds the shaft 41 around the axis (the θ direction) and is fixed to the shaft 41. The rotor magnet 44 is fixed to an outer side surface of the rotor core 43 along an axis thereof. The rotor core 43 and the rotor magnet 44 are rotated integrally with the shaft 41.

### Stator

The stator 50 surrounds the rotor 40 around the axis (the θ direction) and rotates the rotor 40 around the central axis J. The stator 50 has the core back section 51, teeth sections 52, a coil 53 and a bobbin (an insulator) 54. A shape of the core back section 51 is a cylindrical shape that is concentric with the shaft 41.

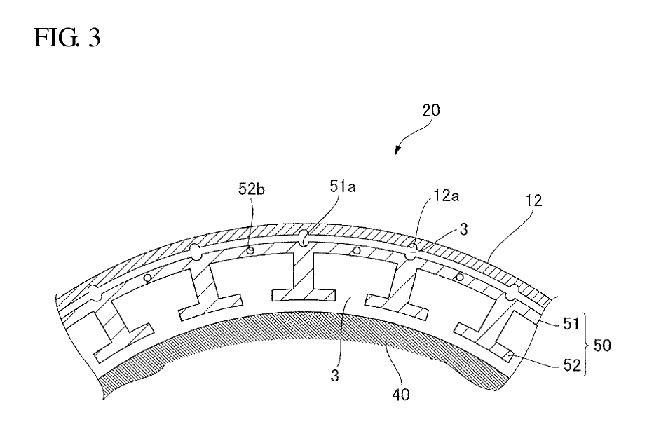

The teeth sections 52 extend from the inner side surface of the core back section 51 toward the shaft 41. The plurality of teeth sections 52 are provided and disposed on the inner side surface of the core back section 51 at equal intervals (FIG. 3) in the circumferential direction. The coil 53 is configured by winding a conductive wire 53a. The coil 53 is provided on the bobbin (the insulator) 54. The bobbin (the insulator) 54 is mounted on the teeth sections 52.

### Bearing

The bearing 42 is disposed on the rear side (the −Z side) of the stator 50. The bearing 42 is held by a bearing holding section 65 provided in a bus bar holder 61 (to be described below). The bearing 42 supports the shaft 41. A configuration of the bearing 42 is not particularly limited and any known bearing may be used.

### Control Device

The control device 70 controls driving of the motor unit 20. The control device 70 has a circuit board (not shown), a rotation sensor (not shown), a sensor magnet holding member (not shown) and a sensor magnet 73. That is, the motor unit 20 has the circuit board, the rotation sensor, the sensor magnet holding member and the sensor magnet 73.

The circuit board outputs a motor driving signal. The sensor magnet holding member is positioned when a center hole is fitted to a small diameter portion of an end portion of the shaft 41 on the rear side (the +Z side). The sensor magnet holding member is rotatable together with the shaft 41. The sensor magnet 73 has an annular shape, and N poles and S poles are alternately disposed in the circumferential direction. The sensor magnet 73 is fitted to an outer circumferential surface of the sensor magnet holding member.

Accordingly, the sensor magnet 73 is held by the sensor magnet holding member, and disposed to be rotatable with the shaft 41 around the axis of the shaft 41 (+the θ direction) on the rear side (the −Z side) of the bearing 42.

The rotation sensor is attached to a circuit board front surface of the circuit board on the front side (the +Z side). The rotation sensor is provided at a position facing the sensor magnet 73 in the axial direction (the Z-axis direction). The rotation sensor detects variation in magnetic flux of the sensor magnet 73. The rotation sensor is, for example, a Hall IC or an MR sensor. Specifically, when the Hall IC is used, three rotation sensors are provided.

### Cover

The cover 13 is attached to the rear side (the −Z side) of the housing 12. A material of the cover 13 is, for example, a metal. The cover 13 has a tubular section 22a, a lid section 22b and a flange section (a cover side) 24. The tubular section 22a opens on the front side (the +Z side).

The tubular section 22a surrounds the bus bar assembly 60, more specifically, the end portion of the bus bar holder 61 on the rear side (the −Z side) from the outer side in the radial direction from the central axis J. The tubular section 22a is connected to an end portion of the housing 12 on the rear side of the bus bar assembly insertion section 21a via the flange section (the housing side) 15 and the flange section (the cover side) 24.

The lid section 22b is connected to an end portion of the tubular section 22a on the rear side. The lid section 22b of the example embodiment has a flat plate shape. The lid section 22b closes an opening section of the bus bar holder 61 on the rear side. A front surface of the lid section 22b comes in contact with the entire circumference of the rear side O-ring 82. Accordingly, the cover 13 comes in indirect contact with the opening section of the bus bar holder 61 throughout the circumference via a main body section rear surface of the bus bar holder 61 on the rear side and the rear side O-ring 82.

The flange section (the cover side) 24 widens outward from the end portion of the tubular section 22a on the front side in the radial direction. The housing 12 and the cover 13 are adhered to each other as the flange section (the housing side) 15 and the flange section (the cover side) 24 overlap each other.

An external power supply is connected to the motor unit 20 via a connector section 63. The connected external power supply is electrically connected to a bus bar 91 and an interconnection member 92 protruding from a bottom surface of an opening section 63a for a power supply provided in the connector section 63. Accordingly, driving current is supplied to the coil 53 of the stator 50 and the rotation sensor via the bus bar 91 and the interconnection member 92. The driving current supplied to the coil 53 is controlled according to, for example, a rotational position of the rotor 40 measured by the rotation sensor. When the driving current is supplied to the coil 53, a magnetic field is generated and the rotor 40 is rotated by the magnetic field. As a result, the motor unit 20 obtains a rotational driving force.

### Pump Unit

The pump unit 30 is disposed on one side of the motor unit 20 in the axial direction, specifically, on the front side (the +Z axis side). The pump unit 30 is driven by the motor unit 20 via the shaft 41. The pump unit 30 has the pump body 31, a pump rotor 35 and a pump cover 32. Hereinafter, the pump cover 32 and the pump body 31 are referred to as a pump case.

The pump body 31 is fixed into the housing 12 on the front side of the motor unit 20. An O-ring 71 is attached to the pump body 31. The O-ring 71 is provided between the outer circumferential surface of the pump body 31 and the inner circumferential surface of the housing 12 in the radial direction. Accordingly, a space between the outer circumferential surface of the pump body 31 and the inner circumferential surface of the housing 12 in the radial direction is sealed. The pump body 31 has a pump chamber 33 recessed from a surface on the front side (the +Z side) to the rear side (the −Z side) and configured to accommodate the pump rotor 35. A shape of the pump chamber 33 when seen in the axial direction is a circular shape.

The pump body 31 has a through-hole 31a that opens at both ends in the axial direction and through which the shaft 41 passes, an opening on the front side of which opens toward the pump chamber 33. An opening of the through-hole 31a on the rear side opens toward the motor unit 20. The through-hole 31a functions as a bearing member configured to rotatably support the shaft 41.

The pump body 31 has an exposing section 36 disposed in front of the housing 12 and exposed to the outside of the housing 12. The exposing section 36 is a part of an end portion of the pump body 31 on the front side. The exposing section 36 has a columnar shape extending in the axial direction. The exposing section 36 overlaps the pump chamber 33 in the radial direction.

The pump rotor 35 is attached to the shaft 41. More specifically, the pump rotor 35 is attached to an end portion of the shaft 41 on the front side. The pump rotor 35 has an inner rotor 37 attached to the shaft 41, and an outer rotor 38 that surrounds the outer side of the inner rotor 37 in the radial direction. The inner rotor 37 has an annular shape. The inner rotor 37 is a gear having teeth formed on an outer side surface in the radial direction.

The inner rotor 37 is fixed to the shaft 41. More specifically, an end portion of the shaft 41 on the front side is press-fitted into the inner rotor 37. The inner rotor 37 is rotated around the axis (the θ direction) together with the shaft 41. The outer rotor 38 has an annular shape that surrounds an outer side of the inner rotor 37 in the radial direction. The outer rotor 38 is a gear having teeth formed on an inner side surface in the radial direction.

The inner rotor 37 and the outer rotor 38 are meshed with each other, and the outer rotor 38 is rotated as the inner rotor 37 is rotated. That is, the pump rotor 35 is rotated according to rotation of the shaft 41. In other words, the motor unit 20 and the pump unit 30 have the same rotary shaft. Accordingly, an increase in size of the electric oil pump in the axial direction can be minimized. Since the inner rotor 37 and the outer rotor 38 are rotated, a volume between the meshed portions of the inner rotor 37 and the outer rotor 38 varies. A region in which a volume is reduced is referred to as a pressurized region, and a region in which a volume is increased is referred to as a depressurized region. A suction port 32c is disposed on one side of the depressurized region of the pump rotor 35 in the axial direction. In addition, a discharge port 32d is disposed on one side of the pressurized region of the pump rotor 35 in the axial direction. Here, oil suctioned from the suction port 32c into the pump chamber 33 can be accommodated into a volume portion between the inner rotor 37 and the outer rotor 38 and can be sent toward the discharge port 32d. After that, the oil is discharged from the discharge port 32d.

The pump cover 32 is attached to the front side of the pump body 31. The pump cover 32 has a pump cover main body 32a and a cylindrical discharge section 32b for a pump. The pump cover main body 32a has a disk shape expanding in the radial direction. The pump cover main body 32a closes an opening of the pump chamber 33 on the front side. The cylindrical discharge section 32b for a pump has a cylindrical shape extending in the axial direction. The cylindrical discharge section 32b for a pump opens at both ends in the axial direction. The cylindrical discharge section 32b for a pump extends forward from the pump cover main body 32a.

The pump unit 30 has the discharge port 32d and the suction port 32c. The discharge port 32d and the suction port 32c are installed on the pump cover 32. The discharge port 32d includes the inside of the cylindrical discharge section 32b for a pump. The discharge port 32d and the suction port 32c open to the front surface of the pump cover 32. The discharge port 32d and the suction port 32c are connected to the pump chamber 33, and suction of the oil to the pump chamber 33 and discharge of the oil from the pump chamber 33 become possible.

When the shaft 41 is rotated in one direction (a −θ direction) in the circumferential direction, the oil from the suction port 32c is suctioned to the pump chamber 33. The oil suctioned to the pump chamber 33 is delivered by the pump rotor 35 and discharged to the discharge port 32d. Further, in the pump device 10 of the example embodiment, the oil suctioned to the pump chamber 33 is delivered by the pump rotor 35 and flows into the motor unit 20 via the shaft 41. Specifically, although most of the oil is discharged from the pressurized region to the discharge port 32d, some of the oil passes through a gap between the inner rotor 37 and the pump body 31 in the axial direction and flows to the vicinity of the shaft 41. After that, the oil passes through a space between the shaft 41 and the pump body 31 and flows into the motor unit 20. Accordingly, the motor unit 20 can be cooled.

Next, a cooling structure provided in the pump device 10 according to the example embodiment will be described. In the example embodiment, the oil supplied from the external apparatus is suctioned into the motor unit 20 while flowing from the suction port 32c to the discharge port 32d using the pump rotor 35, and cooling of the stator 50 and the rotor 40 can be realized through circulation in the motor unit 20.

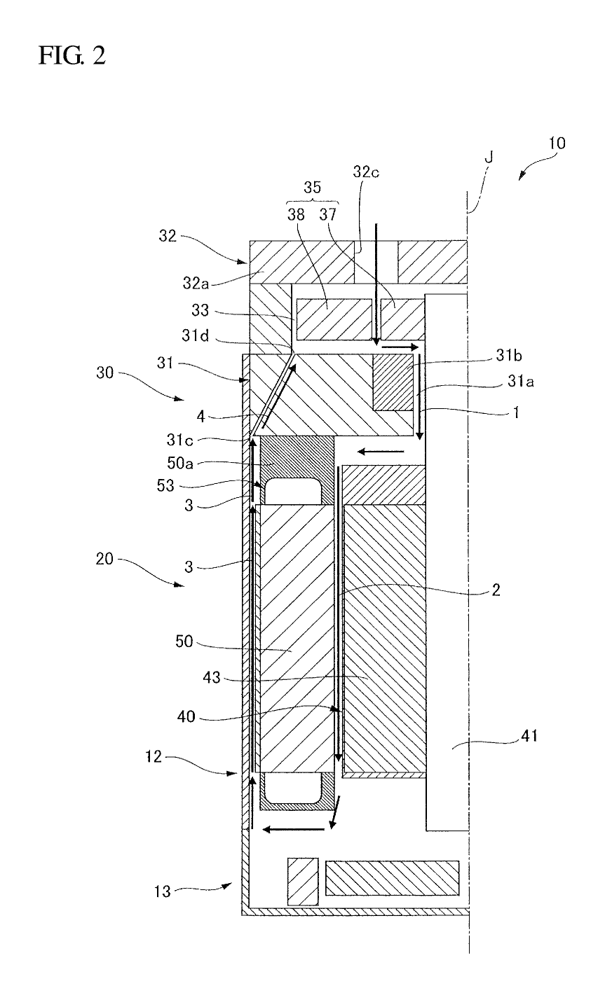

FIG. 2 is a view schematically showing a main part of the pump device 10 for the purpose of easy understanding of a flow path of oil in the pump device 10 shown in FIG. 1.

As shown in FIG. 2, the pump device 10 has a first flow path 1 configured to connect the inside of the pump unit 30 and the inside of the housing 12, a second flow path 2 provided between the stator 50 and the rotor 40, a third flow path 3 provided outside the stator 50 and the rotor 40 in the radial direction, and a fourth flow path 4 (an oil return path) configured to cause oil from the second flow path 2 or the third flow path 3 to flow into the pump unit 30. Hereinafter, each of the flow paths will be described.

### First Flow Path

The first flow path 1 in FIG. 2 is provided between the pump body 31 of the pump unit 30 and the shaft 41. During an operation of the pump device 10, while most of the oil suctioned from the suction port 32c is discharged from the pressurized region of the pump rotor 35 to the discharge port 32d (see FIG. 1), some of the oil passes through a gap between the inner rotor 37 and the pump body 31 in the axial direction and flows to the vicinity of the shaft 41. After that, the oil passes through a space between the shaft 41 and the pump body 31, i.e., the first flow path 1 and flows into the motor unit 20. Further, for the purpose of convenience, FIG. 2 shows that the oil suctioned from the suction port 32c will lead to the first flow path 1 as it is. That is, in arrows showing the flow path shown in FIG. 2, a route in which the oil suctioned from the suction port 32c passes through the gap between the inner rotor 37 and the pump body 31 in the axial direction from the pressurized region to the pump rotor 35 and flows to the first flow path 1 is omitted.

In the example embodiment, the pump body 31 has a slide bearing structure, i.e., a bearing member 31b, and the first flow path 1 is disposed between the outer circumferential surface of the shaft 41 and the inner circumferential surface of the pump body 31. Here, the oil flowing from the pump unit 30 in the first flow path 1 can be used as lubricating oil, and the oil can be efficiently suctioned into the motor unit 20. Further, in the first flow path 1, a notch may be formed at least one of the outer circumferential surface of the shaft 41 and the inner circumferential surface of the pump body 31. Accordingly, a flow path resistance of the first flow path 1 is reduced, and oil can be more efficiently suctioned from the pump unit 30 to the motor unit 20.

Further, the bearing member 31b is not limited to the slide bearing. For example, any ball bearing may be used as the bearing member 31b. In this case, the first flow path 1 is disposed between the bearing member 31b (a bearing) and the pump body 31. Like the case of the slide bearing, in the first flow path 1, a notch or a through-hole may be formed in at least one of the bearing member 31b (the bearing) and the pump body 31. Accordingly, a flow path resistance of the first flow path 1 is reduced, and oil can be more efficiently suctioned from the pump unit 30 to the motor unit 20. When the bearing member 31b is a ball bearing having a plurality of balls, the first flow path 1 may be disposed between the neighboring balls.

### Second Flow Path

The second flow path 2 in FIG. 2 is provided between the stator 50 and the rotor 40. In an example shown in FIG. 2, the second flow path 2 is disposed between the inner circumferential surface of the stator 50 and the outer circumferential surface of the rotor 40. The oil flowed into the first flow path 1 flows from one end of the second flow path 2 on the front side to one end on the rear side.

Further, the second flow path 2 is not limited to between the inner circumferential surface of the stator 50 and the outer circumferential surface of the rotor 40. For example, a through-hole may be formed in the core back section 51 (see FIG. 1) of the stator 50 or the rotor core 43, and the through-hole may be used as the second flow path 2. That is, the second flow path 2 may be provided at an arbitrary position as long as the position is disposed between the stator 50 and the rotor 40. Accordingly, the rotor can be cooled while more efficiently cooling the coil 53 of the stator 50.

As shown in FIG. 2, one end of the first flow path 1 on the side of the motor unit 20 is provided in the vicinity of the through-hole 31a on the side of the motor unit as the opening section of the pump body 31 through which the shaft 41 passes. For this reason, since the second flow path 2 is provided at a position connected to (in the vicinity of) one end of the first flow path 1 on the side of the motor unit 20, most of the oil is discharged from the discharge port 32d (see FIG. 1). That is, since a distance from the discharge port 32d to the first flow path 1 is increased, an amount of oil flowing toward the first flow path 1 is smaller than an amount of oil discharged from the discharge port 32d. Accordingly, since a discharge pressure of the pump is not impaired, performance deterioration of the pump can be minimized.

### Third Flow Path

The third flow path 3 in FIG. 2 is provided outside the stator 50 and the rotor 40 in the radial direction. Further, the case in which the third flow path 3 is provided inside the stator 50 and the rotor 40 in the radial direction will be described below in detail. In the example shown in FIG. 2, the third flow path 3 is disposed between the outer circumferential surface of the stator 50 and the inner circumferential surface of the housing 12.

The oil flowed into the first flow path 1 flows from one end of the third flow path 3 on the rear side to one end on the front side via the second flow path 2. Since a surface area in which the stator 50 contacts with the oil can be increased by providing the third flow path 3, the stator 50 can be more efficiently cooled. In general, in the motor, the coil generates the most heat. The heat generated by the coil is transmitted to the stator core. That is, a calorific value of the stator 50 in the motor unit 20 is large. Accordingly, the ability to efficiently cool the stator 50 means that the motor unit 20 can be efficiently cooled.

As shown in FIG. 3, the third flow path 3 has a notch 51a formed in the outer circumferential surface of the core back section 51. In addition, the third flow path 3 may have a notch 12a formed in the inner circumferential surface of the housing 12. The third flow path 3 may have both of the notch 51a and the notch 12a or may have one of them. Further, a place on the stator 50 in which the notch is formed is not limited to the outer circumferential surface, and for example, may be provided on the inner circumferential surface.

When the stator 50 has the notch 51a, since a surface area in which the stator 50 contact with oil can be increased, the inside of the motor unit 20 can be more efficiently cooled. In addition, when the stator 50 has the notch 51a or the housing 12 has the notch 12a, since a flow rate of the oil flowing into the third flow path 3 can be increased, the oil can be more efficiently circulated.

Further, the third flow path 3 is not limited to a space between the outer circumferential surface of the stator 50 and the inner circumferential surface of the housing 12. For example, as shown in FIG. 3, a through-hole 52b may be formed in the core back section 51 of the stator 50, and the through-hole 52b may be used as the third flow path 3. Accordingly, the coil 53 of the stator 50 can be efficiently cooled. In addition, a space between the neighboring teeth sections 52 may be provided as the third flow path 3.

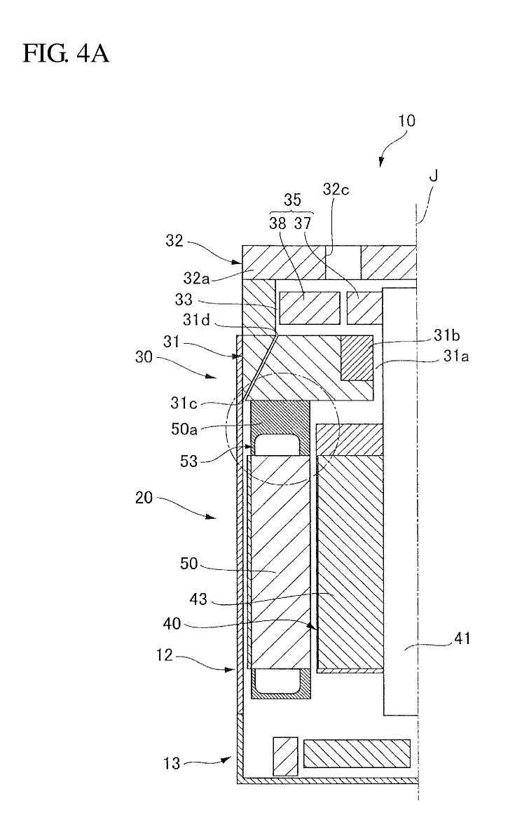

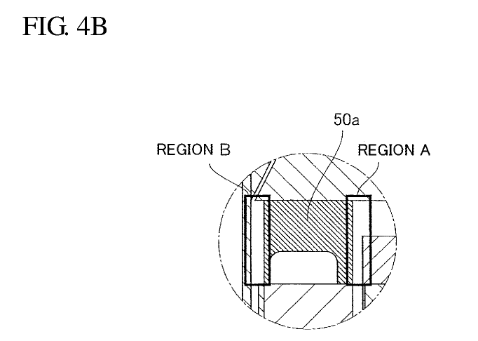

In the example embodiment, the stator 50 and the pump body 31 are in contact with each other. As shown in FIGS. 4A and 4B, the stator 50 is molded of a resin. That is, the stator 50 is an integrally molded product molded of a resin, and has a structure in which one end 50a of the stator 50 on the front side comes in contact with the pump body 31. Specifically, an area except the inner circumferential surfaces of the teeth sections 52 (see FIG. 3) and the outer end of the core back section 51 is molded of a resin. That is, the coil is coated with a resin as a whole. As shown in FIGS. 4A and 4B, since the stator 50 molded of a resin and the pump body 31 come in contact with each other while having an annular contact section in the circumferential direction, a region A into which oil from the first flow path 1 flows and a region B connected from the third flow path 3 to the fourth flow path 4 are divided. Accordingly, the oil flowed from the first flow path 1 into the region A does not diverge to the region B. For this reason, the oil flowed into the motor unit 20 can flow through the first flow path 1, the second flow path 2 and the third flow path 3 in sequence, and an unnecessary circulation route is not provided. That is, the circulating oil is difficult to stay. Accordingly, heat of the oil is efficiently transferred through the flow paths in sequence.

Further, in the example embodiment, since the stator 50 is molded, while one end on the front side at which the stator 50 comes in contact with the pump body 31 is provided, there is no limitation thereto. For example, since a ring member is fitted between the stator 50 and the pump body 31, the stator 50 and the pump body 31 may come in contact with each other. As shown in FIGS. 4A and 4B, the coil end of the stator 50 may not be coated with a resin, and the one end 50a of the stator 50 on the front side may have any shape as long as the region A and the region B are divided.

When the stator 50 is molded of a resin, in the second flow path 2 and the third flow path 3, a surface area in which the stator 50 comes in contact with oil can be increased. For this reason, the inside of the motor unit 20 can be more efficiently cooled. Like the stator 50, the rotor 40 may be molded of a resin. That is, the rotor 40 may be an integrally molded product formed of a resin. Since a surface area of the second flow path 2 in which the rotor 40 comes in contact with oil can be increased by molding the rotor 40, further cooling of the rotor magnet 44 becomes possible, demagnetization of the rotor magnet 44 can be suppressed, and thus, the motor unit 20 can be efficiently cooled.

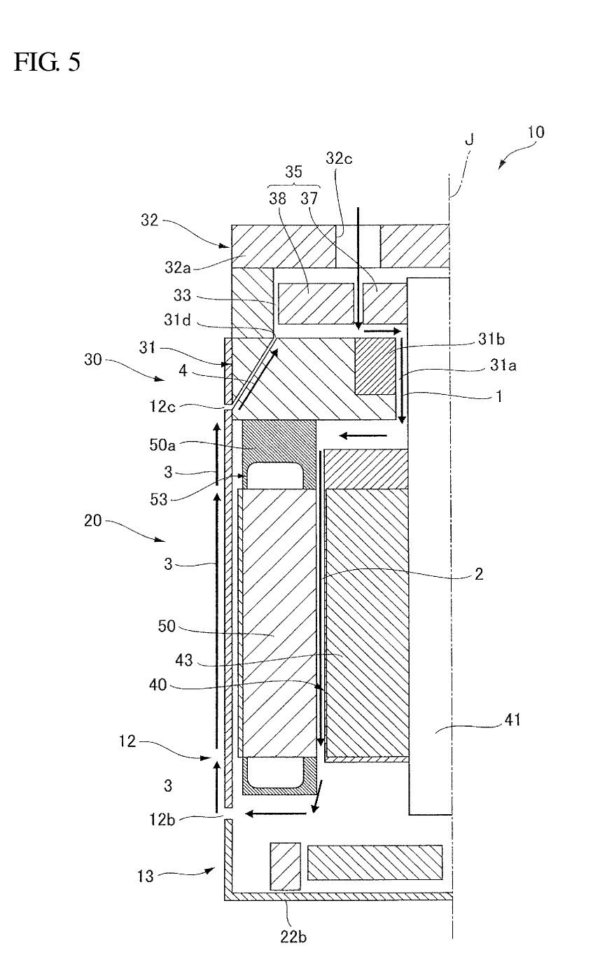

In addition, in the example shown in FIG. 2, while the third flow path 3 is disposed inside the housing 12, there is no limitation thereto. The third flow path 3 may be disposed outside the stator 50 and the rotor 40 in the radial direction, and for example, may be disposed outside the housing 12. A variant of the above-mentioned third flow path 3 will be described below using FIG. 5.

### Fourth Flow Path

The fourth flow path 4 in FIG. 2 is provided in the pump body 31 and connects the third flow path 3 and the inside of the pump unit 30. Specifically, the fourth flow path 4 has a first opening section 31c in the vicinity of one end of the third flow path 3 of the motor unit 20 on the front side, and a second opening section 31d in the vicinity of the suction port 32c of the pump chamber 33. The fourth flow path 4 connects the third flow path 3 of the motor unit 20 and the pump chamber 33. Since the fourth flow path 4 is provided, the oil suctioned into the motor unit 20 via the first flow path 1 can be circulated from the inside of the motor unit 20 to the inside of the pump unit 30. The oil flowed from the first flow path 1 into the motor unit 20 is returned into the pump unit 30 from the fourth flow path 4 without passing through the useless circulation route as described above. Since a temperature of the oil passing through the first flow path 1 is lower than a temperature of the oil passing through the fourth flow path 4, the oil having a low temperature normally circulates through the inside of the motor unit 20. Accordingly, efficient cooling of the stator 50 and the rotor 40 can be realized.

The first flow path 1 is disposed inside the fourth flow path 4 in the radial direction. Accordingly, a distance between the first flow path 1 and the fourth flow path 4 in a direction perpendicular to the axial direction can be secured. When a distance between the first flow path 1 and the fourth flow path 4 is short, the oil having a high temperature that has returned into the pump unit 30 through the fourth flow path 4 may return to the first flow path 1. However, in the example embodiment, since the distance between the first flow path 1 and the fourth flow path 4 in the direction perpendicular to the axial direction can be secured, it is possible to prevent a flow path through which the oil having a high temperature that has returned into the pump unit returns to the first flow path 1 from being created. Accordingly, the inside of the motor unit 20 can be efficiently cooled.

A cross-sectional area of the first opening section 31c that is the opening section of the fourth flow path 4 on the rear side is smaller than a cross-sectional area of the discharge port 32d of the pump unit 30. Accordingly, an amount of the oil flowing into the pump unit 30 from the inside of the motor unit 20 is smaller than a discharge amount of the pump, and an amount of the oil flowing into the motor unit 20 can be suppressed from becoming excessive. That is, the inside of the motor unit 20 can be more efficiently cooled while suppressing a decrease in pump efficiency occurred due to an excessive amount of oil flowing into the motor unit 20.

### Variant of Flow Path

In the example shown in FIG. 2, the third flow path 3 is disposed between the outer circumferential surface of the stator and the inner circumferential surface of the housing 12. However, the third flow path 3 is not limited thereto, and for example, may be provided outside the housing 12. For example, as shown in FIG. 5, a first through-hole 12b and a second through-hole 12c are provided in the housing 12. The oil from the second flow path 2 is discharged to the outside of the housing 12 via the first through-hole 12b, flows from the rear side to the front side of the pump device 10, and flows to the fourth flow path 4 via the second through-hole 12c.

Here, third flow path 3 is provided in the pump device, and an external apparatus (not shown) to which the pump device is attached. The third flow path 3 includes an arbitrary flow path from the first through-hole 12b to the second through-hole 12c. Positions of the first through-hole 12b and the second through-hole 12c are not limited to the positions shown in FIG. 5 and may be provided at arbitrary positions such as side surfaces of the housing 12, the lid section 22b of the cover 13, or the like.

The pump device 10 may further have, for example, a flow path provided between the outer circumferential surface of the shaft 41 and the inner circumferential surface of the rotor 40 as another flow path. In addition, for example, a through-hole (not shown) may be formed in the rotor 40, and the through-hole may be used as a flow path. In this way, since another flow path is provided in addition to the first flow path 1 to the fourth flow path 4, the oil can be more efficiently circulated between the pump unit 30 and the motor unit 20, and the motor unit 20 can be efficiently cooled.

According to the example embodiment, the pump device 10 has the shaft 41 that rotates about a central axis extending in the axial direction, the motor unit 20 configured to rotate the shaft 41, and the pump unit 30 disposed on one side of the motor unit 20 in the axial direction, driven by the motor unit 20 via the shaft 41 and configured to discharge oil, and the motor unit 20 has the rotor 40 that rotates around the shaft 41, the stator 50 disposed to face the rotor 40, and the housing 12 configured to accommodate the rotor 40 and the stator 50. The pump unit 30 has the pump rotor 35 attached to the shaft 41, and a pump case (31 and 32), in which the suction port 32c configured to suction oil and the discharge port 32d configured to discharge oil are provided, configured to accommodate the pump rotor 35. The pump device 10 has the first flow path 1 for oil configured to connect the inside of the pump unit 30 and the inside of the housing 12, the second flow path 2 for oil provided between the stator 50 and the rotor 40, the third flow path 3 for oil provided outside in the radial direction or inside in the radial direction of the stator 50 and the rotor 40, and the fourth flow path 4 configured to cause the oil from the second flow path 2 or the third flow path 3 to flow through the pump unit 30.

The pump device 10 causes the oil to flow through the motor unit 20 using pressurization of the pump rotor 35. Here, in order to realize oil circulation in the motor, the fourth flow path 4 that functions as an oil return path is provided. Accordingly, in the pump device 10, the oil can circulate in the motor with no decrease in performance of the pump, and the rotor 40 and the stator 50 of the motor unit 20 of the pump device 10 can be simultaneously cooled. That is, it is possible to provide the pump device 10 having a structure with an excellent cooling effect.

### Second Example Embodiment

Next, a pump device according to a second example embodiment of the present disclosure will be described. In the first example embodiment, a motor unit has a configuration of an inner rotor type motor in which a stator is disposed outside a rotor in the radial direction. On the other hand, the motor unit according to the example embodiment has a configuration of an axial gap type motor in which two rotors attached to the shaft 41 at a predetermined interval in the axial direction are provided and a stator is disposed between the two rotors. Hereinafter, a difference from the first example embodiment will be mainly described. In the pump device according to the example embodiment, the same configurations as those of the pump device according to the first example embodiment are designated by the same reference numerals, and description thereof will be omitted.

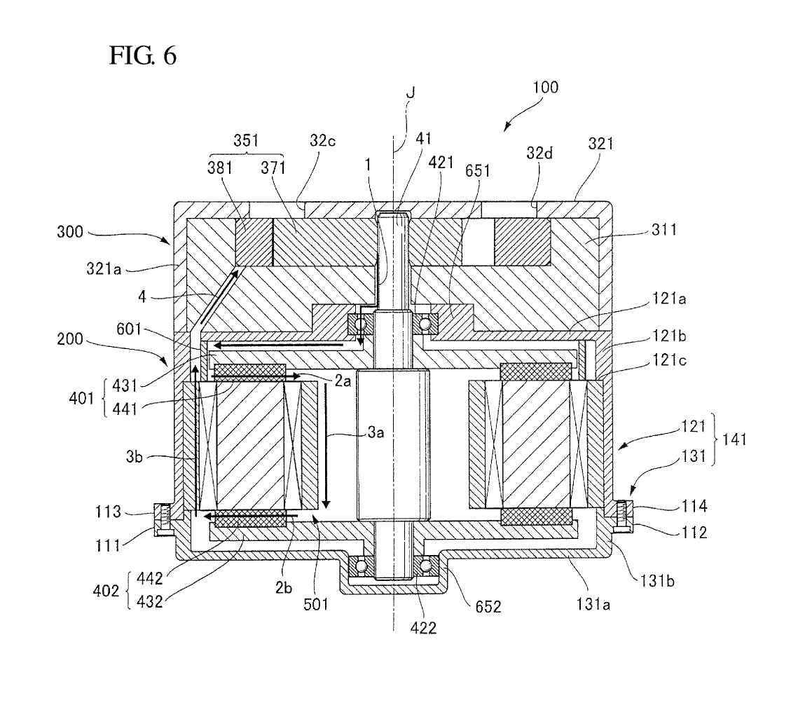

FIG. 6 is a cross-sectional view showing a pump device 100 of the example embodiment.

As shown in FIG. 6, the pump device 100 has a shaft 41, a motor unit 200, a housing 141 and a pump unit 300. The shaft 41 is rotated about the central axis J extending in the axial direction. The motor unit 200 and the pump unit 300 are provided to be arranged in the axial direction.

The motor unit 200 has an upper rotor 401, a lower rotor 402, a stator 501, an upper bearing member 421, a lower bearing member 422, a bus bar assembly (not shown) and a connector (not shown). Each of the lower rotor 402 and the upper rotor 401 has a disk shape extending in the radial direction. The upper rotor 401 has a plurality of upper magnets 441 arranged on a surface (a −Z side surface) facing the stator 501 in the circumferential direction, and an upper rotor yoke 431 configured to hold the upper magnets 441.

The lower rotor 402 has lower magnets 442 and a lower rotor yoke 432. The lower rotor 402 has the plurality of lower magnets 442 arranged on a surface (the −Z side surface) facing the stator 501 in the circumferential direction, and a lower rotor yoke 432 configured to hold the lower magnets 442. That is, the upper magnets 441 and the lower magnets 442 are disposed to face both surfaces of the stator 501 in the axial direction. The upper rotor yoke 431 and the lower rotor yoke 432 are fixed to the outer circumferential surface of the shaft 41 coaxially with each other.

The upper bearing member 421 and the lower bearing member 422 rotatably support the shaft 41. The upper bearing member 421 is fixed to the housing 141. The stator 501 has a plurality of (in the second example embodiment, 12) cores, each of which has a fan shape when seen in a plan view, arranged in the circumferential direction, coils provided on the cores, respectively, coil extension lines extracted from the coils of the cores, respectively, a mold resin configured to integrally fix the plurality of cores, and a plurality of extension line support sections provided on an outer circumferential end of the stator 501.

The housing 141 constitutes a casing of the motor unit 200. The stator 501 is held on a substantially central section of the housing 141 in the axial direction. The lower rotor 402 is accommodated in the stator 501 on the rear side (the −Z side). Further, a bus bar assembly (not shown) may be accommodated. The upper rotor 401 is accommodated in the stator 501 on the front side (the +Z side). The housing 141 has a first housing 121 having a covered cylindrical shape, a rear side of which is open, a second housing (a cover) 131 having a bottomed cylindrical shape connected to a rear side (a −Z side) of the first housing 121. A material of the housing 141 is, for example, a metal or a resin.

A stepped section 121c is formed on an inner circumferential surface of a cylindrical section 121b of the first housing 121. The stator 501 is held by the stepped section 121c. The first housing 121 has a disk-shaped top wall 121a, and an upper bearing holding section 651 provided on a central section of the top wall 121a. The upper bearing holding section 651 is fitted into a rear opening section of the pump unit 300. The upper bearing holding section 651 holds the upper bearing member 421.

The second housing 131 has a disk-shaped bottom wall 131a, a cylindrical cover section 131b extending from a circumferential edge portion of the bottom wall 131a toward the front side (the +Z side), and a lower bearing holding section 652 provided on a central section of the bottom wall 131a. The cylindrical cover section 131b is fixed to an opening section of the first housing 121 on the rear side (the −Z side). More specifically, the first housing 121 and the second housing 131 are fixed using flange sections 111 and 112 of the second housing 131 and flange sections 113 and 114 of the first housing 121 through a method such as bolt fastening or the like.

When a bus bar assembly (not shown) is accommodated in the second housing 131, a through-hole (not shown) passing in the axial direction is formed in the bottom wall 131a of the second housing 131, and a connector (not shown) is attached to the through-hole. An external connection terminal (not shown) extending from the bus bar assembly to the rear side (the −Z side) through the bottom wall 131a is disposed on the connector.

The pump unit 300 is disposed on one side of the motor unit 200 in the axial direction, specifically, on the front side (the +Z axis side). The pump unit 300 is driven by the motor unit 200 via the shaft 41. The pump unit 300 has the pump body 311, the pump rotor 351 and the pump cover 321. The pump rotor 351 has the inner rotor 371 and the outer rotor 381. The pump cover 321 has the suction port 32c and the discharge port 32d. Description of the members provided in the pump unit 300 is omitted because the description is the same as that of the first example embodiment.

Next, a cooling structure provided in the pump device 100 according to the example embodiment will be described. Like the case of the first example embodiment, cooling of the stator 501 and the rotor (the upper rotor 401 and the lower rotor 402) can be realized by suctioning the oil into the motor unit 200 and circulating the oil in the motor unit 200 while the oil supplied from the external apparatus flows from the suction port 32c to the discharge port 32d using the pump rotor 351. Hereinafter, a flow path of oil in the pump device 100 will be described while focusing a difference from the first example embodiment.

As shown in FIG. 6, the pump device 100 has the first flow path 1 configured to connect the inside of the pump unit 300 and the inside of the housing 141, the second flow path 2a or 2b provided between the stator 501 or the upper rotor 401 and the lower rotor 402, the third flow path 3a or 3b provided inside in the radial direction or outside in the radial direction of the stator 501 and the upper rotor 401 or the lower rotor 402, and the fourth flow path 4 (the oil return path) configured to cause the oil from the second flow path 2a or 2b or the third flow path 3a or 3b into the pump unit 300.

Since the first flow path 1 and the fourth flow path 4 of the example embodiment are the same as those of the first example embodiment, description thereof will be omitted. In the example embodiment, as shown in FIG. 6, the second flow path includes the following two flow paths. The second flow path 2a, which is first, is disposed between the upper rotor 401 and one end of the stator 501 facing the upper magnet 441 of the upper rotor 401 in the axial direction. The second flow path 2b, which is second, is disposed between the lower rotor 402 and one end of the stator 501 facing the lower magnet 442 of the lower rotor 402 in the axial direction. Accordingly, the stator 501, the upper rotor 401 and the lower rotor 402 can be simultaneously cooled.

In the example embodiment, as shown in FIG. 6, the third flow path includes the following two flow paths. The third flow path 3a, which is first, is disposed between the stator 501 and the shaft 41, i.e., inside the stator 501 and the upper rotor 401 and the lower rotor 402 in the radial direction. The third flow path 3b, which is second, is disposed between the stator 501 and the housing 141 that holds the stator 501.

That is, the third flow path 3b is disposed outside the stator 501, the upper rotor 401 and the lower rotor 402 in the radial direction. Accordingly, in the example embodiment, the third flow path 3 is provided inside the stator 501, the upper rotor 401 and the lower rotor 402 in the radial direction and outside the stator 501, the upper rotor 401 and the lower rotor 402 in the radial direction. Even in the example embodiment, like the first example embodiment, the pump device 100 has a structure configured to simultaneously cool the stator 501, the upper rotor 401 and the lower rotor 402 and having an excellent cooling effect.

In the example embodiment, a ring member 601 is provided between one end of the stator 501 on the front side in the axial direction and the top wall 121a of the first housing 121. Accordingly, the ring member 601 comes in contact with the stator 501 and the pump body 311 while annular contact sections thereof are provided, and like the first example embodiment, a region into which oil from the first flow path 1 flows and a region that continues from the third flow path 3b to the fourth flow path 4 are divided. Accordingly, the oil flowed from the first flow path 1 is not divided to the fourth flow path 4. For this reason, in the motor unit 200, a circulation route of oil in the stator 501, the upper rotor 401 and the lower rotor 402 can be provided in addition to circulation of the oil from the first flow path 1 to the fourth flow path 4 only, and a structure having an excellent cooling effect in the motor unit 200 is provided.

Further, like FIG. 5 of the first example embodiment, a through-hole may be formed in the housing 141, and the oil from the second flow path 2b may be discharged to the outside of the housing 141. In this case, the third flow path 3b is disposed outside the housing 141.

In addition, in the pump device 100 of the example embodiment, while the case in which the stator 501 is fixed to the cylindrical section 121b of the housing 141 has been described, there is no limitation thereto. The present disclosure can also be applied to the case in which the stator 501 of the pump device 100 is fixed to the shaft 41, and the pump device 100 has a cooling structure using the same flow path.

In addition, while the case in which the motor unit 200 of the pump device 100 has both of the upper rotor 401 and the lower rotor 402 has been described in the example embodiment, there is no limitation thereto. For example, the present disclosure can also be applied to the pump device 100 having the lower rotor 402 only. In this case, the pump device 100 has only the second flow path 2b as the second flow path.

### Third Example Embodiment

Next, a pump device according to a third example embodiment of the present disclosure will be described. In the first example embodiment, the motor unit 20 of the pump device 10 has the configuration of the inner rotor type motor, and in the second example embodiment, the motor unit 200 of the pump device 100 has the configuration of the axial gap type motor. On the other hand, the motor unit according to the example embodiment has a configuration of an outer rotor type motor in which a stator is disposed in a rotor in the radial direction. Hereinafter, a difference from the first example embodiment and the second example embodiment will be mainly described. In the pump device according to the example embodiment, the same components as those of the pump device according to the first example embodiment or the second example embodiment are designated by the same reference numerals, and description thereof will be omitted.

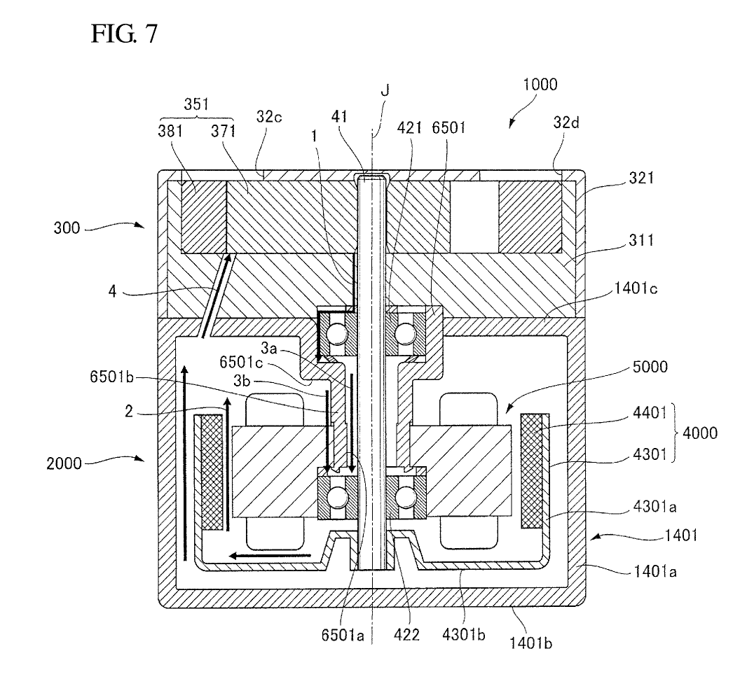

FIG. 7 is a cross-sectional view showing a pump device 1000 of the example embodiment.

The pump device 1000 of the example embodiment has a shaft 41, a motor unit 2000 and a pump unit 300. The shaft 41 rotates about the central axis J extending in the axial direction. The motor unit 2000 and the pump unit 300 are provided to be arranged in the axial direction.

As shown in FIG. 7, the motor unit 2000 has a housing 1401, a rotor 4000, a stator 5000, a bearing housing 6501, an upper bearing member 421, a lower bearing member 422, a control device (not shown) and a bus bar assembly (not shown). Further, the control device and the bus bar assembly may not be built in the motor unit 2000, and for example, may be attached to one end of the housing 1401 on the rear side in the axial direction or may be attached to a side surface 1401a of the housing 1401.

The rotor 4000 has the rotor magnet 4401 and a rotor yoke 4301. The rotor yoke 4301 has a cup shape (a front side opening), which has a top plate section 4301b having a disk shape, to which the shaft 41 is connected at a center thereof, and a cylindrical section 4301a extending forward from an outer circumference of the top plate section 4301b. The rotor magnet 4401 is disposed on an inner circumferential surface of the cylindrical section 4301a of the rotor yoke 4301, and the inner circumferential surface faces the stator 5000 in the radial direction. The rotor 4000 is fixed to the shaft 41.

The bearing housing 6501 has a bearing housing cylindrical section 6501b having a cylindrical shape, an annular protrusion 6501a formed on an inner circumferential surface of the bearing housing cylindrical section 6501b, and a brim section 6501c formed on an outer circumferential surface of the bearing housing cylindrical section 6501b. The annular protrusion 6501a protrudes inward such that an inner diameter of the bearing housing cylindrical section 6501b is reduced.

In the inner circumferential surface of the bearing housing cylindrical section 6501b, the upper bearing member 421 is provided on the front side. In the inner circumferential surface of the bearing housing cylindrical section 6501b, the lower bearing member 422 is provided on the rear side. The upper bearing member 421 and the lower bearing member 422 are fitted onto the shaft 41. The upper bearing member 421 and the lower bearing member 422 rotatably support the shaft 41 with respect to the bearing housing 6501.

The stator 5000 is fixed to an outer circumference of the bearing housing 6501. Specifically, the bearing housing 6501 is fitted into an inner circumferential surface of an annular core back of the stator 5000. A top wall 1401c of the housing 1401 connected to an opening section of the pump unit 300 on the rear side is disposed on the front side of the stator 5000 and supports the bearing housing 6501. The control device (not shown) is disposed between a bottom wall 1401b of the housing 1401 and the stator 5000.

Next, a cooling structure provided in the pump device 1000 according to the example embodiment will be described. Like the case of the first example embodiment, the oil supplied from the external apparatus flows from the suction port 32c to the discharge port 32d using the pump rotor 351, and is suctioned into the motor unit 2000 to circulate through the motor unit 2000. Cooling of the stator 5000 and the rotor 4000 can be realized by the circulation. Hereinafter, in the flow path of the oil in the pump device 1000, a difference from the first example embodiment and the second example embodiment will be mainly described.

As shown in FIG. 7, the pump device 1000 has the first flow path 1 configured to connect the inside of the pump unit 300 and the inside of the housing 1401, the second flow path 2 provided between the stator 5000 and the rotor 4000, the third flow path 3a or 3b provided inside the stator 5000 and the rotor 4000 in the radial direction, and the fourth flow path 4 (the oil return path) configured to cause the oil from the second flow path 2 or the third flow path 3a or 3b to flow into the pump unit 300.

Since the first flow path 1 and the fourth flow path 4 of the example embodiment are the same as those of the first example embodiment, description thereof will be omitted. In the example embodiment, as shown in FIG. 7, the second flow path 2 is disposed between the outer circumferential surface of the stator 5000 and the inner circumferential surface of the rotor 4000. In the example embodiment, as shown in FIG. 7, the third flow path includes the following two flow paths. The third flow path 3a, which is first, is disposed between the bearing housing 6501 and the shaft 41. The third flow path 3b, which is second, is disposed between the stator 5000 and the bearing housing 6501. That is, both of the third flow path 3a and the third flow path 3b are disposed inside the stator 5000 and the rotor 4000 in the radial direction.

In the example embodiment, the oil flowed into the first flow path 1 flows to the second flow path 2 via the third flow path 3a or 3b. Then, the second flow path 2 is connected to the fourth flow path 4, and the oil is returned to the pump unit 300. Further, the oil flows from the second flow path 2 to the outer circumferential surface of the rotor yoke 4301 and the inner circumferential surface of the housing 1401. In this case, the oil is collected in the bottom wall 1401b of the housing 1401, and the oil flows through a space between the outer circumferential surface of the rotor yoke 4301 and the inner circumferential surface of the housing 1401 in the direction of the pump unit 300. An arrow in FIG. 7 showing the flow path between the rotor yoke 4301 and the housing 1401 shows the above-mentioned case.

Further, like the first example embodiment and the second example embodiment, a through-hole may be formed in the housing 1401, and the oil from the second flow path 2 may be discharged to the outside of the housing 1401. In this case, the third flow path includes a flow path disposed outside the housing 1401, i.e., a flow path disposed outside the stator 5000 and the rotor 4000 in the radial direction.

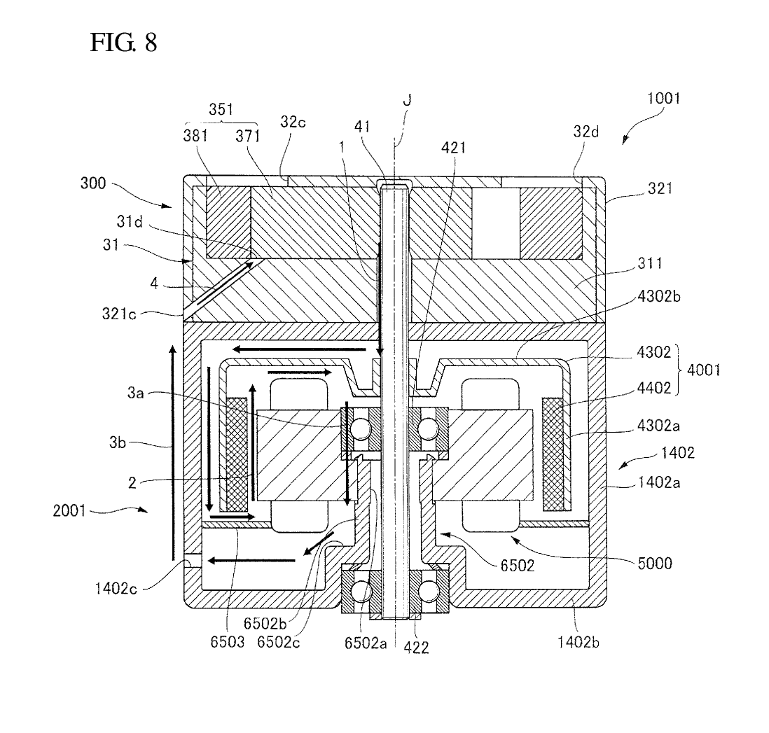

FIG. 8 is a cross-sectional view of another pump device 1001 according to the example embodiment.

The pump device 1001 of the example embodiment has a shaft 41, a motor unit 2001 and a pump unit 300. The shaft 41 rotates about the central axis J extending in the axial direction. The motor unit 2001 and the pump unit 300 are provided to be arranged in the axial direction.

The pump device 1000 shown in FIG. 7 and the pump device 1001 shown in FIG. 8 have different motor units. The same components as those in FIG. 7 are designated by the same reference numerals, and description thereof will be omitted. As shown in FIG. 8, the motor unit 2001 has a housing 1402, a rotor 4001, a stator 5000, a bearing housing 6502, an upper bearing member 421, a lower bearing member 422, a control device (not shown) and a bus bar assembly (not shown). Further, the control device and the bus bar assembly may not be built in the motor unit 2001, and for example, may be attached to one end of the housing 1402 on the rear side in the axial direction or may be attached to a side surface of the housing 1402.

The rotor 4001 has a rotor magnet 4402 and a rotor yoke 4302. The rotor yoke 4302 is different from the pump device 1000 in FIG. 7 and has a cup shape with a rear side opening. The rotor yoke 4302 has a disk-shaped top plate section 4302b to which the shaft 41 is connected at a center thereof, and a cylindrical section 4302a extending rearward from an outer circumference of the top plate section 4302b. The rotor magnet 4402 is disposed on an inner circumferential surface of the cylindrical section 4302a of the rotor yoke 4302, and the inner circumferential surface faces the stator 5000 in the radial direction. The rotor 4001 is fixed to the shaft 41.

The bearing housing 6502 has a bearing housing cylindrical section 6502b having a cylindrical shape, an annular protrusion 6502a provided on an inner circumferential surface of the bearing housing cylindrical section 6502b, and a brim section 6502c provided on an outer circumferential surface of the bearing housing cylindrical section 6502b. The annular protrusion 6502a protrudes inward such that an inner diameter of the bearing housing cylindrical section 6502b is reduced.

In the inner circumferential surface of the bearing housing cylindrical section 6502b, the lower bearing member 422 is provided on the rear side. In the inner circumferential surface of the bearing housing cylindrical section 6502b, the upper bearing member 421 is provided on the front side. The upper bearing member 421 and the lower bearing member 422 are fitted onto the shaft 41. The upper bearing member 421 and the lower bearing member 422 rotatably support the shaft 41 with respect to the bearing housing 6502.

The stator 5000 is fixed to an outer circumference of the bearing housing 6502. Specifically, the bearing housing 6502 is fitted into an inner circumferential surface of an annular core back section (not shown) of the stator 5000. A bottom wall 1402b of the housing 1402 is disposed on the rear side of the stator 5000 and supports the bearing housing 6502. The control device (not shown) is disposed between the bottom wall 1402b of the housing 1402 and the stator 5000.

Next, a cooling structure provided in the pump device 1001 according to the example embodiment will be described. A difference from FIG. 7 will be mainly described. As shown in FIG. 8, the pump device 1001 has a first flow path 1 configured to connect the inside of the pump unit 300 and the inside of the housing 1402, a second flow path 2 provided between the stator 5000 and the rotor 4001, a third flow path 3a or 3b provided inside in the radial direction or outside in the radial direction of the stator 5000 and the rotor 4001, and a fourth flow path 4 (an oil return path) configured to cause oil from the third flow path 3b to flow into the pump unit 300.

In the example embodiment, the oil flowed into the motor unit 2001 from the first flow path 1 flows along the top plate section 4302b of the rotor yoke 4302 and flows between the cylindrical section 4302a and a side surface 1402a of the housing 1402. In the example embodiment, a ring member 6503 configured to connect a rear side coil end of the stator 5000 and a side surface of the housing 1402 is provided. Accordingly, the oil flowing between the cylindrical section 4302a of the rotor yoke 4302 and the side surface 1402a of the housing 1402 flows to the second flow path 2 provided between the stator 5000 and the rotor 4001.

In the example embodiment, as shown in FIG. 8, the third flow path includes the following two flow paths. The third flow path 3a, which is first, is disposed between the stator 5000 and the shaft 41, i.e., inside the stator 5000 and the rotor 4001 in the radial direction. The third flow path 3b, which is second, is disposed outside the housing 1402 by forming a through-hole 1402c in the side surface 1402a of the housing. Specifically, the third flow path 3b is a flow path from the through-hole 1402c to a through-hole 321c and outside the stator 5000 and the rotor 4001 in the radial direction.

Accordingly, in the example embodiment, the third flow path is in the case provided only inside the stator 5000 and the rotor 4000 in the radial direction (FIG. 7) and in the case provided both of outside in the radial direction and inside in the radial direction of the stator 5000 and the rotor 4001 (FIG. 8). Even in the example embodiment, like the first example embodiment, the pump device has a structure that simultaneously cools the stator and the rotor and has an excellent cooling effect.

Hereinabove, while the example embodiments of the present disclosure have been described, the present disclosure is not limited to these example embodiments and various modifications and changes may be made without departing from the spirit of the present disclosure.

Priority is claimed on Japanese Patent Application No. 2016-195279, filed Sep. 30, 2016, the content of which is incorporated herein by reference.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-16. (canceled)

17. A pump device comprising:
a shaft that rotates about a central axis extending in an axial direction;
a motor to rotate the shaft; and
a pump disposed on one side of the motor in the axial direction and driven by the motor via the shaft to discharge oil; wherein
the motor includes:
a rotor that rotates around the shaft;
a stator facing the rotor; and
a housing to accommodate the rotor and the stator;
the pump includes:
a pump rotor attached to the shaft; and
a pump case to accommodate the pump rotor and including a suction port that suctions the oil and a discharge port that discharges the oil;
the pump device further comprises:
a first flow path for the oil to connect an interior of the pump and an interior of the housing;
a second flow path for the oil provided between the stator and the rotor;
a third flow path for the oil provided outside in a radial direction or inside in the radial direction of the stator and the rotor; and
a fourth flow path to cause the oil from the second flow path or the third flow path to flow into the pump.

18. The pump device according to claim 17, wherein
the pump case includes a pump cover and a pump body;
the pump body opens at both ends in the axial direction such that the shaft extends therethrough; and
the pump rotor is rotated by rotation of the shaft.

19. The pump device according to claim 18, wherein the stator and the pump body are capable of contacting each other.

20. The pump device according to claim 17, wherein the first flow path is disposed inside the fourth flow path in the radial direction.

21. The pump device according to claim 17, wherein a cross-sectional area of an opening section of the fourth flow path is smaller than a cross-sectional area of the discharge port of the pump.

22. The pump device according to claim 17, wherein the stator is an integrally molded product made of a resin.

23. The pump device according to claim 17, wherein the rotor is an integrally molded product made of a resin.

24. The pump device according to claim 17, wherein
the stator is provided outside the rotor in the radial direction; and
the third flow path is provided outside the stator in the radial direction.

25. The pump device according to claim 24, wherein the third flow path is provided between an outer circumferential surface of the stator and an inner circumferential surface of the housing of the motor.

26. The pump device according to claim 25, wherein the third flow path includes a through-hole or a notch in the stator, or a notch in the housing.

27. The pump device according to claim 24, wherein
one end of the first flow path on a side of the motor is provided at or adjacent to an opening section of the pump case, through which the shaft extends, on the side of the motor; and
the second flow path is connected to one end of the first flow path on the side of the motor.

28. The pump device according to claim 24, further comprising a flow path provided between an outer circumferential surface of the shaft and an inner circumferential surface of the rotor.

29. The pump device according to claim 24, further comprising a flow path extending through the through-hole in the rotor.

30. The pump device according to claim 17, wherein
the stator is provided inside the rotor in the radial direction; and
the third flow path is provided outside the stator and the rotor in the radial direction and provided outside the stator and the rotor in the radial direction.

31. The pump device according to claim 17, wherein
the rotor and the stator face each other in the axial direction; and
the third flow path is provided outside the stator and the rotor in the radial direction and provided outside the stator and the rotor in the radial direction.

32. The pump device according to claim 31, wherein
the motor includes two rotors;
the two rotors are attached to the shaft with a predetermined interval therebetween in the axial direction;
the stator is disposed between the two rotors; and
the second flow path includes a flow path provided between one of the two rotors and the stator and a flow path provided between the other of the two rotors and the stator.
